(19) United States
(12) Patent Application Publication
(10) Pub. No.: US 2011/0078350 A1
(43) Pub. Date: Mar. 31, 2011

(54) METHOD FOR GENERATING MULTIPLE SERIAL BUS CHIP SELECTS USING SINGLE CHIP SELECT SIGNAL AND MODULATION OF CLOCK SIGNAL FREQUENCY

(75) Inventor: John M. Carls, Austin, TX (US)

(73) Assignee: VIA TECHNOLOGIES, INC., Taipei (TW)

(21) Appl. No.: 12/770,398

(22) Filed: Apr. 29, 2010

Related U.S. Application Data
(60) Provisional application No. 61/247,288, filed on Sep. 30, 2009.

(51) Int. Cl. G06F 13/42; G06F 1/08; G06F 1/14

(52) U.S. Cl. 710/110; 713/501; 713/502

(57) ABSTRACT

A system includes a serial bus having an electrical net for conveying a clock signal, and a master device and a plurality of slave devices coupled to the serial bus. The master device modulates a clock signal on its output on an electrical net according to first and second manners to select respective first and second of the slave devices. The first manner is distinct from the second manner. In alternate embodiments, the first and second manners are: (1) different frequencies of the clock signal; and (2) pulse trains on the clock signal with different predetermined numbers of clock edges prior to the assertion of a single slave select signal from the master device. In alternate embodiments: (1) each slave detects the first and second manners directly from the master; and (2) a distinct device detects the first and second manners from the master device and generates individual slave selects.

### CROSS REFERENCE TO RELATED APPLICATION(S)

This application claims priority based on U.S. Provisional Application Ser. No. 61/247,288, filed Sep. 30, 2009, entitled METHOD FOR GENERATING MULTIPLE SERIAL BUS CHIP SELECTS USING SINGLE CHIP SELECT SIGNAL AND MODULATION OF CLOCK SIGNAL FREQUENCY, which is hereby incorporated by reference in its entirety.

### FIELD OF THE INVENTION

The present invention relates in general to the field of communication using serial buses in computer systems, and particularly to selection between multiple recipients of the communication.

### BACKGROUND OF THE INVENTION

Serial buses are popularly used in computer systems because they have certain advantages over parallel buses, such as lower pin count where an integrated circuit may be pin-limited, smaller physical cable size, reduced likelihood of crosstalk, and so forth. In some configurations, the serial buses are used in point-to-point communication between two devices. However, in some serial bus configurations, it is desirable and/or necessary for multiple devices on the serial bus to be able to communicate. This requires a means for the initiating device to indicate which of the other multiple possible target devices it wishes to communicate with. What is needed is a means of accomplishing this without increasing the number of signals on the serial bus, which might negate the benefits sought in selecting a serial bus.

### BRIEF SUMMARY OF INVENTION

In one aspect the present invention provides a device for individually selecting a plurality of slave devices coupled to a serial bus. The master device includes a master serial port interface configured for coupling to the serial bus. The master serial port interface has an output for transmitting a clock signal from the master device to the plurality of slave devices. The master device also includes a processor coupled to the master serial port interface. The processor is configured to control the master serial port interface to modulate the clock signal on the output according to a first manner to select a first of the plurality of slave devices and to modulate the clock signal on the output according to a second manner to select a second of the plurality of slave devices. The first manner is distinct from the second manner.

In another aspect, the present invention provides a system. The system includes a serial bus having an electrical net for conveying a clock signal. The system also includes a plurality of slave devices coupled to the serial bus. The system also includes a master device coupled to the serial bus. The master device comprises an output coupled to the electrical net for transmitting a clock signal to individually select the plurality of slave devices. The master device is configured to modulate the clock signal on the output according to a first manner to select a first of the plurality of slave devices and to modulate the clock signal on the output according to a second manner to select a second of the plurality of slave devices, wherein the first manner is distinct from the second manner.

In yet another aspect, the present invention provides a method for a master device coupled to a serial bus to individually select a plurality of slave devices coupled to the serial bus, wherein the serial bus has a single electrical path for conveying a clock signal from the master device to the plurality of slave devices. The method includes modulating the clock signal on the single electrical path according to a first manner to select a first of the plurality of slave devices. The method also includes modulating the clock signal on the single electrical path according to a second manner to select a second of the plurality of slave devices. The first manner is distinct from the second manner.

In alternate embodiments, the first and second manners are: (1) different frequencies of the clock signal; and (2) pulse trains on the clock signal with different predetermined numbers of clock edges prior to the assertion of a single slave select signal from the master device. In alternate embodiments: (1) each slave detects the first and second manners directly from the master; and (2) a distinct device detects the first and second manners from the master device and generates individual slave selects. Combinations of the alternate embodiments are encompassed.

### BRIEF DESCRIPTION OF THE DRAWINGS

FIG. 1 is a block diagram illustrating a microprocessor according to the present invention.

FIGS. 2 and 3 are block diagrams illustrating configurations that employ a serial bus in a conventional configuration and manner.

FIGS. 4 through 7 are block diagrams illustrating respective embodiments that employ a serial bus in a configuration and manner according to the present invention.

### DETAILED DESCRIPTION OF THE INVENTION

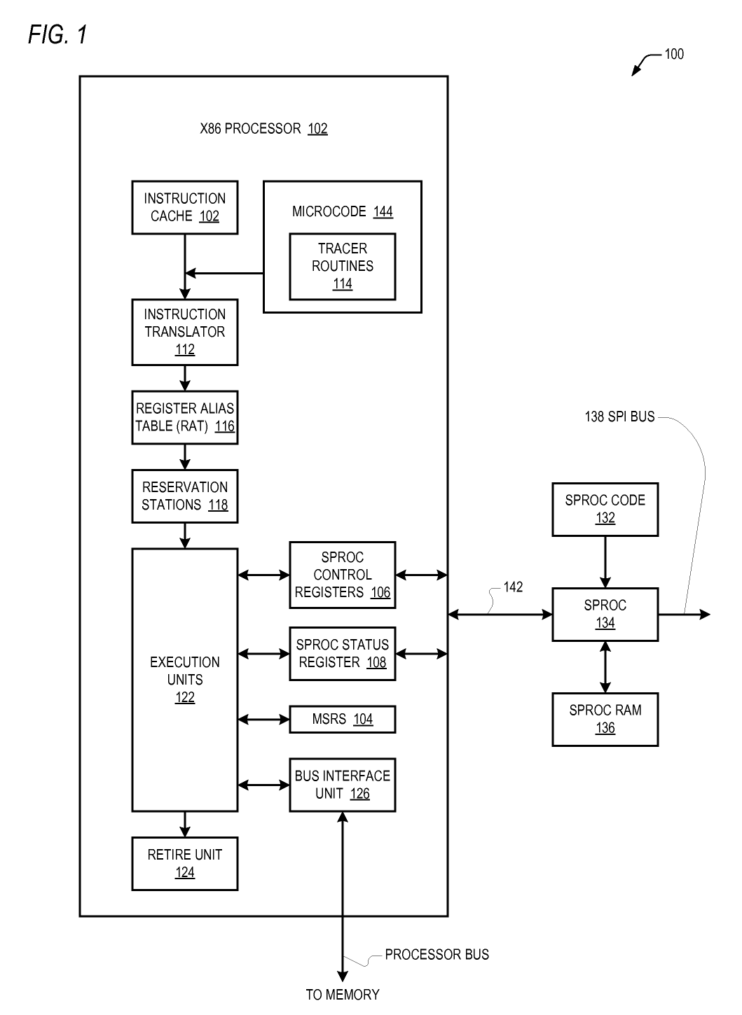

Referring now to FIG. 1, a block diagram illustrating a microprocessor 100 according to the present invention is shown. The microprocessor 100 includes both a main processor 102 and a service processor (SPROC) 134 on a single integrated circuit. The term “main processor” or “processor” or “microprocessor” used herein refers to the non-service processor 134 portion of the integrated circuit 100. In one embodiment, the main processor 102 is an x86 (also referred to as IA-32) architecture processor 102; however, other processor architectures may be employed. A processor is an x86 architecture processor if it can correctly execute a majority of the application programs that are designed to be executed on an x86 processor. An application program is correctly executed if its expected results are obtained. In particular, the main processor 102 executes instructions of the x86 instruction set and includes the x86 user-visible register set.

The main processor 102 includes an instruction cache 102 and a microcode unit 144, each of which provides instructions to an instruction translator 112. The microcode 144 includes tracer routines 114. The tracer 114 is a set of microcode routines that lie dormant until activated by a software write to a control register (e.g., WRMSR instruction). Tracer is used as a tool to debug and performance tune the processor 102. Once activated, various events can trigger the tracer 114 to gather processor 102 state information and write it to specified addresses in memory so that it can be captured by a logic analyzer monitoring the external processor bus.

The instruction translator 112 translates the received instructions into microinstructions. The instruction translator 112 may invoke the microcode 144, such as a tracer routine 114, in response to decoding one of a predetermined set of instructions of the instruction set architecture of the main processor 102. The instruction translator 112 provides the microinstructions to a register alias table (RAT) 116 that generates instruction dependencies and maintains a table thereof.

The main processor 102 also includes a plurality of execution units 122 that execute the microinstructions. Reservation stations 118 associated with the execution units 122 hold microinstructions waiting to be issued to the execution units 122 for execution. The RAT 116 receives the microinstructions in program order and may dispatch them to the reservation stations 118 out of program order subject to the dependencies. A retire unit 124 retires the instructions in program order.

The main processor 102 also includes a bus interface unit 126 that interfaces the main processor 102 to a processor bus that couples the main processor 102 to the rest of the system, such as to memory and/or a chipset.

The main processor 102 also includes model specific registers (MSR) 104. The MSRs 104 are user-programmable. Specifically, a user may program the MSRs 104 to control tracer 114 operation.

The main processor 102 also includes SPROC control registers 106 and an SPROC status register 108, coupled to the execution units 122, which enable communication between the main processor 102 and the SPROC 134. The SPROC control registers 106 and SPROC status register 108 are coupled to the SPROC 134 via a bus 142. As shown in FIG. 1, the SPROC 134 has its own code 132 that it executes, its own RAM 136 for storing log information, and its own serial port interface (SPI) 138 through which it can transmit the log to an external device. Advantageously, the SPROC 134 can also instruct tracer 114 running on the main processor 102 to store the log information from the SPROC RAM 136 to system memory, as discussed in more detail below.

There are asynchronous events that can occur with which the tracer microcode 114 cannot deal well. However, advantageously, the SPROC 134 can be commanded by the processor 102 to detect the events and to perform actions (discussed below, such as creating a log itself) in response to detecting the events. The SPROC 134 can itself provide the log information to the user, and it can also interact with the tracer 114 to request the tracer 114 to provide the log information or to request the tracer 114 to perform other actions, as discussed below. Examples of the events that SPROC 134 can detect include:
1. The processor 102 is hung. That is, the processor 102 has not retired any instructions for a number of clock cycles that is programmable via an MSR 104. In one embodiment, the processor 102 includes a counter that is loaded with the MSR 104 value each time the processor 102 retires an instruction; otherwise, the counter counts up every clock cycle. If the counter overflows, hardware within the processor 102 sets a bit within the SPROC status register 108 (discussed below) to indicate a processor 102 hung event. This is particularly useful in determining which instruction was executing when the processor 102 hung.
2. The processor 102 loads data from an uncacheable region of memory. In one embodiment, the memory subsystem hardware sets the corresponding bit within the SPROC status register 108.
3. A change in temperature of the processor 102 occurs. In one embodiment, the temperature change is indicated by a temperature sensor included within the integrated circuit 100.
4. The operating system requests a change in the processor's 102 bus clock ratio, which changes the internal clock frequency of the processor 102, and/or requests a change in the processor's 102 voltage level. In one embodiment, microcode that services the operating system request sets the corresponding bit within the SPROC status register 108.
5. The processor 102, of its own accord, changes the voltage level and/or bus clock ratio, e.g., to achieve power savings or performance improvement.
6. An internal timer of the processor 102 expires.
7. A cache snoop that hits a modified cache line causing the cache line to be written back to memory occurs. One method used to debug the processor 102 is to compare the tracer 114 log information with the execution results of a software functional model simulator that simulates the processor 102. In order to simulate the operation of the processor 102 in response to an external event, such as the generation of a cache snoop request by the chipset, the simulator must be told about the external event. Thus, it is advantageous that SPROC 134/tracer 114 detect and log the event and when it occurred in the actual operation of the processor 102 because it enables the debugger to provide the time of the occurrence of the hit-modifying snoop to the simulator to aid in debugging.
8. The temperature, voltage, or bus clock ratio of the processor 102 goes outside a respective range that may be programmed via an MSR 104.
9. An external trigger signal is asserted by a user on an external pin of the integrated circuit 100.

Advantageously, because the SPROC 134 is running code 132 independently of the main processor 102, it does not have the same limitations as the tracer 114 microcode. Thus, it can detect or be notified of the events independent of the processor 102 instruction execution boundaries and without disrupting the state of the processor 102.

The SPROC 134 is configured for coupling to the SPI bus 138 that enables the SPROC 134 to communicate with peripherals outside the integrated circuit 100.

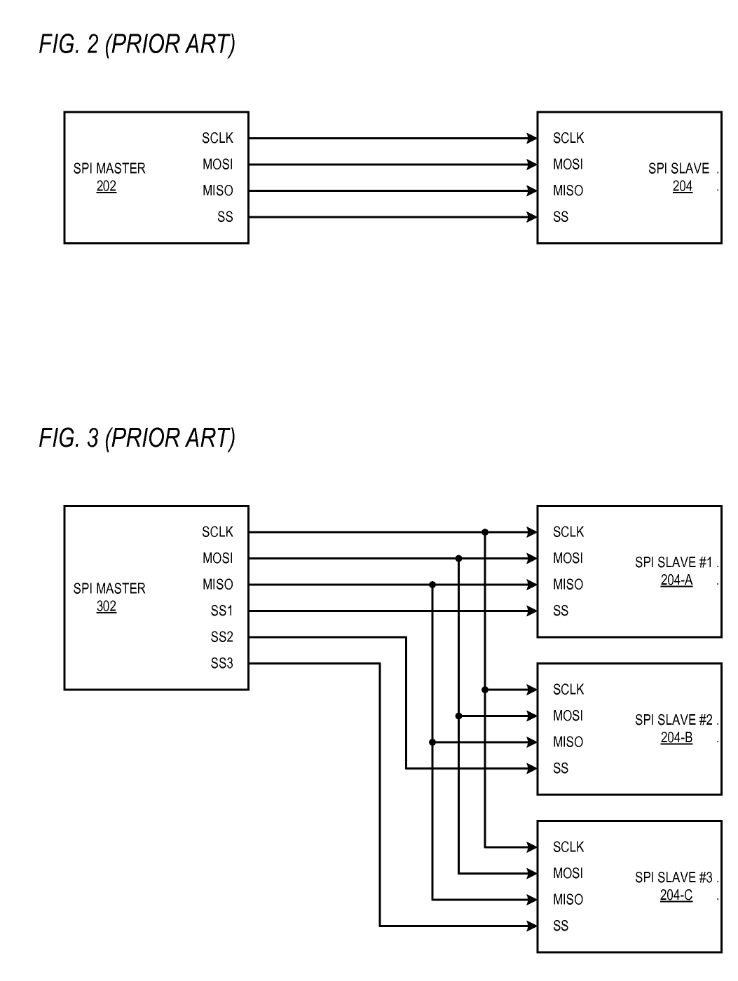

Referring now to FIGS. 2 and 3, block diagrams illustrating configurations that employ an SPI bus in a conventional configuration and manner are shown. A conventional SPI bus is a serial bus that has 4 signals: a clock (SCLK), master data output/slave data input (MOSI), master data input/slave data output (MISO), and slave select (SS), as shown in FIG. 2. The SS signal is active low. The slave sources the MISO signal, and the master sources the SCLK, MOSI, and SS signals.

There may be cases where it is desirable for the master to communicate with multiple slaves on the single SPI bus. To do this conventionally, the master provides multiple SS signals, one for each slave, as shown in FIG. 3. This has the disadvantage of increasing the number of signals—the very thing one is generally trying to avoid by using a serial bus.

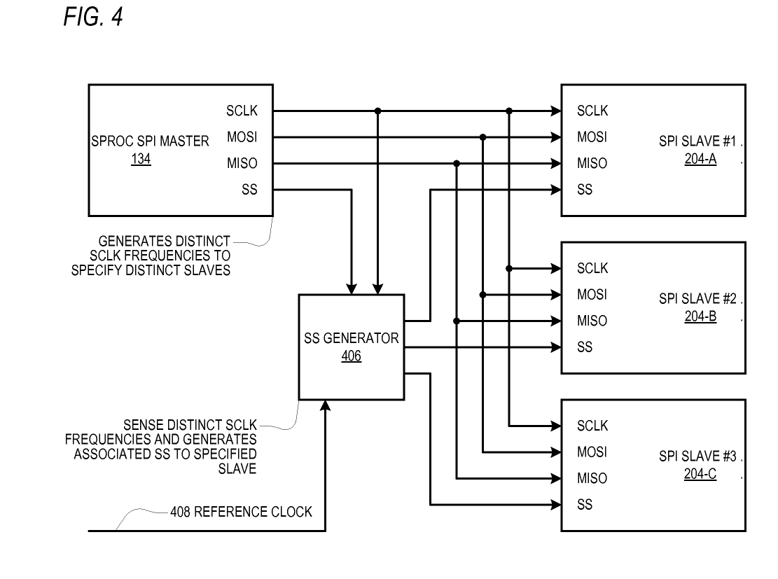

Embodiments will now be described with respect to FIGS. 4 through 7 that solve the problem described above by using the SPI bus SCLK signal, in combination with the single SS signal, to select one of multiple SPI slaves. In particular, the multiple slaves may include devices to monitor the temperature, voltage, and/or frequency of the chip 100; debug devices, such as a port 80 card, debug header, or FLASH memory for storing debug data; devices for controlling system devices such as fan speed.

Referring now to FIGS. 4 through 7, block diagrams illustrating respective embodiments that employ an SPI bus in a configuration and manner according to the present invention is shown. The embodiments of FIGS. 4 through 7 may be employed in a system that includes the microprocessor 100 of FIG. 1, including the SPI bus 138 of FIG. 1, although their use is not limited to the embodiment of FIG. 1 or to embodiments that involve a microprocessor.

In the embodiment of FIG. 4, the SPI master of the SPROC 134 generates distinct frequencies on SCLK to specify distinct slaves. For example, to communicate with slave #1 204-A, the SPROC master 134 might generate a 50 MHz signal; to communicate with slave #2 204-B, the SPROC master 134 might generate a 60 MHz signal; and to communicate with slave #3 204-C, the SPROC master 134 might generate a 70 MHz signal. The host platform, such as a motherboard, includes a slave select (SS) generator 406 that receives the SCLK and SS signals from the SPROC master 134. The SS generator 406 also receives a reference clock signal 408. For example, the reference clock may be a 10 MHz clock signal. The SS generator 406 generates a unique chip select for each of the SPI slaves 204-A/B/C based on the relationship between the SCLK frequency and the reference clock 408 frequency, namely their ratio. Continuing with the example above, when the SPROC master 134 wants to communicate with slave #2 204-B it generates a 60 MHz clock signal on SCLK and asserts SS, and the SS generator 406 detects this combination and responsively generates a true value (a low value according to the SPI convention) on the SS signal to SPI slave #2 204-B, while continuing to generate a false value on the SS signal to SPI slave #1 204-A and to SPI slave #3 204-C.

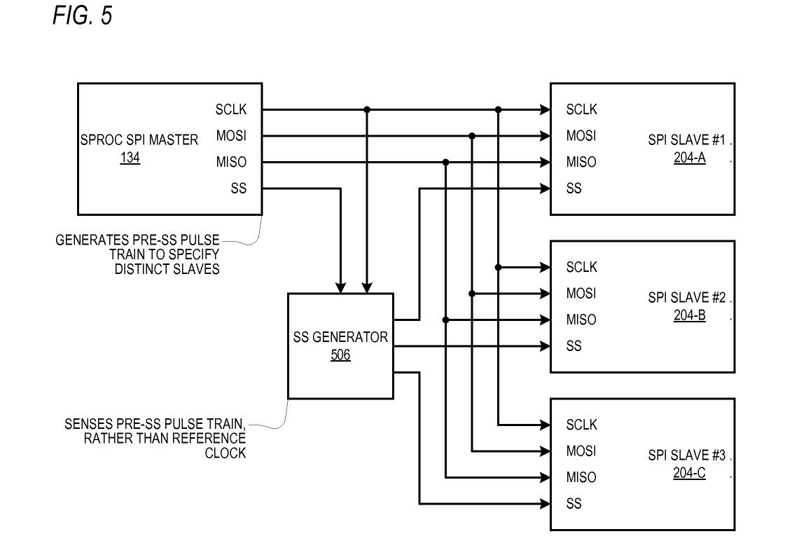

The embodiment of FIG. 5 is similar to the embodiment of FIG. 4. However, the SS generator 406 does not require a reference clock. Instead, prior to asserting SS, the SPROC master 134 generates a pulse train on SCLK with one of a distinct number of clock edges associated with the distinct one of the multiple slaves 204 with which the SPROC master 134 wants to communicate. The SS generator 406 includes a counter that counts the number of SCLK clock edges prior to the assertion of SS. The SS generator 406 uses the counter value to decide which of the SS signals to the slaves 204 to assert. For example, the SPROC master 134 and SS generator 406 may employ a convention such that a pre-SS pulse train having 10 clock edges specifies slave #1 204-A, a pre-SS pulse train having 20 clock edges specifies slave #2 204-B, and a pre-SS pulse train having 30 clock edges specifies slave #3 204-C. In one embodiment, the counter is reset when SS is no longer true, i.e., when SS is no longer indicating selection of a slave device. A potential advantage of this embodiment is that, if desired, the SPROC master 134 may communicate with each of the slaves 204 using the same SCLK frequency. An advantage of the embodiments of FIGS. 4 and 5 is that they do no require modification to the SPI slaves 204.

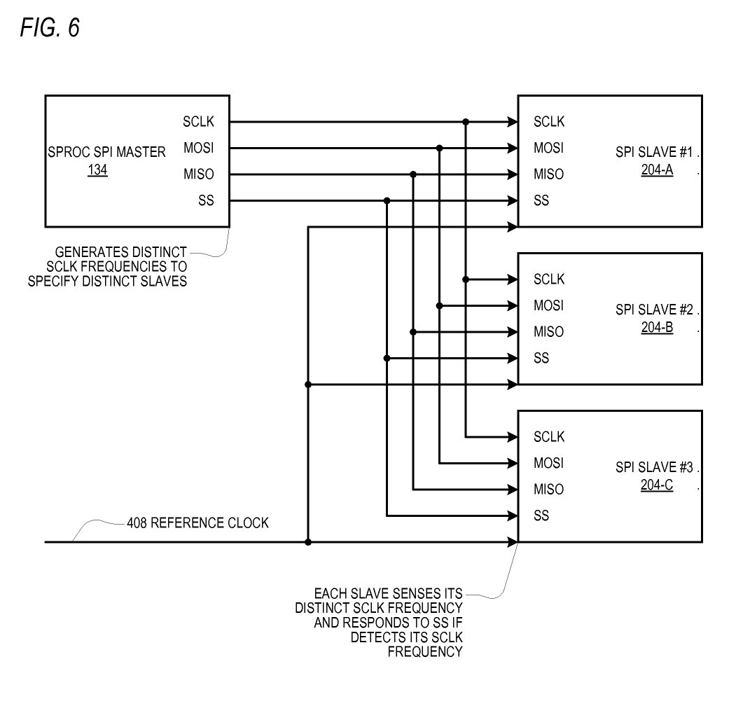

The embodiment of FIG. 6 is similar to the embodiment of FIG. 4 in that the SPROC master 134 generates a distinct SCLK frequency to specify each slave 204; however, the embodiment of FIG. 6 does not require a separate SS generator 406. Rather, in the embodiment of FIG. 6, each slave 204 effectively performs the function of the SS generator 406 of FIG. 4. That is, each slave monitors the relationship between the SCLK frequency and the reference clock 408 frequency and if the relationship (e.g., ratio) between them specifies a particular slave 204, that slave responds to the SS generated by the SPROC master 134, and the other slaves 204 refrain from responding to the SS generated by the SPROC master 134. A potential advantage of this embodiment is that it does not require the separate SS generator 406. A potential disadvantage is that it requires the SPI slave designers to design the SPI slaves to receive and use the reference clock 408.

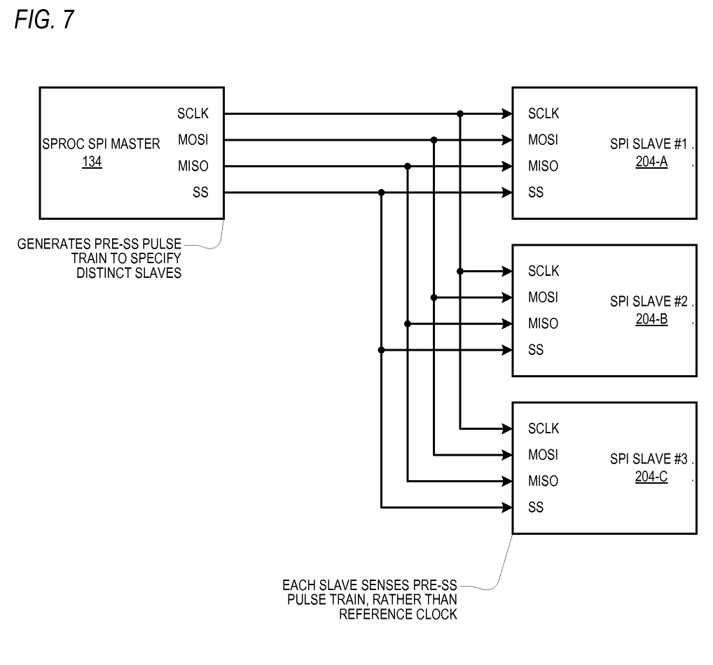

The embodiment of FIG. 7 is similar to the embodiment of FIG. 5 in that the SPROC master 134 generates a distinct pre-SS pulse train to specify each slave 204; however, the embodiment of FIG. 7 does not require a separate SS generator 406. Rather, in the embodiment of FIG. 7, each slave 204 effectively performs the function of the SS generator 406 of FIG. 5. That is, each slave includes a counter and monitors the SCLK signal for its distinctive pulse train count prior to the assertion of SS by the SPROC master 134.

In the embodiments of FIGS. 6 and 7, a means is required to indicate to each slave 204 its identifying frequency/pulse train count. Various embodiments are contemplated, including but not limited to, hardware jumpers, fuses, or distinct hardcoded values of input pins on each slave.

Although embodiments have been described in which the serial bus is an SPI bus, other embodiments are contemplated in which the base bus is other than SPI, but which would also benefit from the technique of communicating multiple virtual slave select signals on a single physical slave select signal by varying the clock signal frequency. Furthermore, although embodiments have been described with three SPI slaves for ease of illustration, the number of slaves with which the SPROC master 134 may communicate in the manners described is limited only by the bus loading limitations imposed by the SPI specification generally.

It is noted that while the electrical nets shown in the accompanying Figures may be a single conducting electrical net, there term electrical net is also intended to encompass a differential pair of conductors.

While various embodiments of the present invention have been described herein, it should be understood that they have been presented by way of example, and not limitation. It will be apparent to persons skilled in the relevant computer arts that various changes in form and detail can be made therein without departing from the scope of the invention. For example, software can enable, for example, the function, fabrication, modeling, simulation, description and/or testing of the apparatus and methods described herein. This can be accomplished through the use of general programming languages (e.g., C, C++), hardware description languages (HDL) including Verilog HDL, VHDL, and so on, or other available programs. Such software can be disposed in any known computer usable medium such as magnetic tape, semiconductor, magnetic disk, or optical disc (e.g., CD-ROM, DVD-ROM, etc.), a network, wire line, wireless or other communications medium. Embodiments of the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the exemplary embodiments described herein, but should be defined only in accordance with the following claims and their equivalents. Specifically, the present invention may be implemented within a microprocessor device which may be used in a general purpose computer. Finally, those skilled in the art should appreciate that they can readily use the disclosed conception and specific embodiments as a basis for designing or modifying other structures for carrying out the same purposes of the present invention without departing from the scope of the invention as defined by the appended claims.

I claim:

1. A device for individually selecting a plurality of slave devices coupled to a serial bus, the master device comprising:
a master serial port interface, configured for coupling to the serial bus, wherein the master serial port interface has an output for transmitting a clock signal from the master device to the plurality of slave devices; and
a processor, coupled to the master serial port interface, wherein the processor is configured to control the master serial port interface to:
modulate the clock signal on the output according to a first manner to select a first of the plurality of slave devices; and
modulate the clock signal on the output according to a second manner to select a second of the plurality of slave devices, wherein the first manner is distinct from the second manner.

2. The device of claim 1,
wherein the master serial port interface is configured to modulate the clock signal on the output according to the first manner by modulating the clock signal on the output at a first frequency during a first period;
wherein the master serial port interface is configured to modulate the clock signal on the output according to the second manner by modulating the clock signal on the output at a second frequency during a second period, wherein the first and second frequencies are distinct.

3. The device of claim 1, wherein the master serial port interface has a second output for transmitting a single slave select signal from the master device to the plurality of slave devices;
wherein the master serial port interface is configured to modulate the clock signal on the output according to the first manner by generating a pulse train with a first predetermined number of clock edges on the first output prior to asserting the slave select signal on the second output;
wherein the master serial port interface is configured to modulate the clock signal on the output according to the second manner by generating a pulse train with a second predetermined number of clock edges on the first output prior to asserting the slave select signal on the second output, wherein the first and second predetermined number of clock edges are distinct.

4. The device of claim 1, wherein the processor is further configured to control the master serial port interface to:
modulate the clock signal on the output according to a third manner to select a third of the plurality of slave devices, wherein the third manner is distinct from the first manner and the second manner.

5. The device of claim 1, wherein the device is comprised within a microprocessor.

6. A system, comprising:
a serial bus, having an electrical net for conveying a clock signal;
a plurality of slave devices, coupled to the serial bus; and
a master device, coupled to the serial bus, wherein the master device comprises an output coupled to the electrical net for transmitting a clock signal to individually select the plurality of slave devices, wherein the master device is configured to:
modulate the clock signal on the output according to a first manner to select a first of the plurality of slave devices; and
modulate the clock signal on the output according to a second manner to select a second of the plurality of slave devices, wherein the first manner is distinct from the second manner.

7. The system of claim 6, further comprising:
a device distinct from the master device and distinct from the plurality of slave devices, wherein the distinct device is coupled to the master device and coupled to the plurality of slave devices, wherein the distinct device is configured to:
detect the first manner and responsively assert a first slave select signal to the first of the plurality of slave devices to select it for the master device; and
detect the second manner and responsively assert a second slave select signal to the second of the plurality of slave devices to select it for the master device.

8. The system of claim 7,
wherein to modulate the clock signal on the output according to the first manner, the master device is configured to modulate the clock signal on the output at a first frequency during a first period;
wherein to modulate the clock signal on the output according to the second manner, the master device is configured to modulate the clock signal on the output at a second frequency during a second period, wherein the first and second frequencies are distinct.

9. The system of claim 8,
wherein the distinct device is configured to determine that the first frequency is a first predetermined ratio of a reference clock signal frequency to determine that the master device is selecting the first of the plurality of slave devices;
wherein the distinct device is configured to determine that the second frequency is a second predetermined ratio of the reference clock signal frequency to determine that the master device is selecting the second of the plurality of slave devices, wherein the first and second predetermined ratios are distinct.

10. The system of claim 7, wherein the master device comprises a second output coupled to a second electrical net for transmitting a slave select signal to the distinct device;
wherein to modulate the clock signal on the first output according to the first manner, the master device is configured to generate a pulse train with a first predetermined number of clock edges on the first output prior to asserting the slave select signal on the second output;
wherein to modulate the clock signal on the first output according to the second manner, the master device is configured to generate a pulse train with a second predetermined number of clock edges on the first output prior to asserting the slave select signal on the second output, wherein the first and second predetermined number of clock edges are distinct.

11. The system of claim 10, wherein the distinct device comprises:
a counter, configured to:
reset its count and then commence counting clock edges on the first output, in response to detecting that the master device has deasserted the slave select signal on the second electrical net; and
stop counting in response to assertion of the slave select signal on the second electrical net;
wherein the distinct device is configured to assert the first slave select signal to the first of the plurality of slave devices to select it for the master device if the count is the first predetermined number;
wherein the distinct device is configured to assert the second slave select signal to the second of the plurality of slave devices to select it for the master device if the count is the second predetermined number.

12. The system of claim 6,
wherein the first of the plurality of slave devices is configured to detect the first manner of the modulation of the clock signal on the electrical net to detect that the master device is selecting the first of the plurality of slave devices;
wherein the second of the plurality of slave devices is configured to detect the second manner of the modulation of the clock signal on the electrical net to detect that the master device is selecting the second of the plurality of slave devices.

13. The system of claim 12,
wherein to detect the first manner of the modulation of the clock signal on the electrical net, the first of the plurality of slave devices is configured to detect the modulation of the clock signal on the electrical net at a first frequency during a first period;
wherein to detect the second manner of the modulation of the clock signal on the electrical net, the second of the plurality of slave devices is configured to detect the modulation of the clock signal on the electrical net at a second frequency during a second period, wherein the first and second frequencies are distinct.

14. The system of claim 13,
wherein to detect the modulation of the clock signal on the electrical net at a first frequency during a first period, the first of the plurality of slave devices is configured to determine that the first frequency is a first predetermined ratio of a reference clock signal frequency;
wherein to detect the modulation of the clock signal on the electrical net at a second frequency during a second period, the second of the plurality of slave devices is configured to determine that the second frequency is a second predetermined ratio of a reference clock signal frequency.

15. The system of claim 12, wherein the master device comprises a second output coupled to a second electrical net for transmitting a slave select signal to the plurality of slave devices;
wherein to detect the first manner of the modulation of the clock signal on the electrical net, the first of the plurality of slave devices is configured to detect a pulse train with a first predetermined number of clock edges on the first electrical net prior to assertion of the slave select signal on the second electrical net;
wherein to detect the second manner of the modulation of the clock signal on the electrical net, the second of the plurality of slave devices is configured to detect a pulse train with a second predetermined number of clock edges on the first electrical net prior to assertion of the slave select signal on the second electrical net, wherein the first and second predetermined number are distinct.

16. The system of claim 15, wherein each of the plurality of slave devices comprises:
a counter, configured to:
reset its count and then commence counting clock edges on the first output, in response to detecting that the master device has deasserted the slave select signal on the second electrical net; and
stop counting in response to assertion of the slave select signal on the second electrical net;
wherein the first of the plurality of slave devices is configured to detect that the master device is selecting it if the count is the first predetermined number;
wherein the second of the plurality of slave devices is configured to detect that the master device is selecting it if the count is the second predetermined number.

17. A method for a master device coupled to a serial bus to individually select a plurality of slave devices coupled to the serial bus, wherein the serial bus has a single electrical path for conveying a clock signal from the master device to the plurality of slave devices, the method comprising:
modulating the clock signal on the single electrical path according to a first manner to select a first of the plurality of slave devices; and
modulating the clock signal on the single electrical path according to a second manner to select a second of the plurality of slave devices, wherein the first manner is distinct from the second manner.

18. The method of claim 1,
wherein said modulating the clock signal on the single electrical path according to the first manner comprises modulating the clock signal on the single electrical path at a first frequency during a first period;
wherein said modulating the clock signal on the single electrical path according to the second manner comprises modulating the clock signal on the single electrical path at a second frequency during a second period, wherein the first and second frequencies are distinct.

19. The method of claim 18, further comprising:
detecting the first frequency to determine that the master device is selecting the first of the plurality of slave devices; and
detecting the second frequency to determine that the master device is selecting the second of the plurality of slave devices.

20. The method of claim 19,
wherein said detecting the first frequency comprises determining that the first frequency is a first predetermined ratio of a reference clock signal frequency to determine that the master device is selecting the first of the plurality of slave devices; and
wherein said detecting the second frequency comprises determining that the second frequency is a second predetermined ratio of the reference clock signal frequency to determine that the master device is selecting the second of the plurality of slave devices, wherein the first and second predetermined ratios are distinct.

21. The method of claim 19, wherein said detecting the first frequency is performed by the first of the plurality of slave devices, wherein said detecting the second frequency is performed by the second of the plurality of slave devices.

22. The method of claim 19, wherein said detecting the first frequency and said detecting the second frequency are performed by a device distinct from the master device and distinct from the plurality of slave devices.

23. The method of claim 22, further comprising:
asserting, by the distinct device, a first slave select signal to the first of the plurality of slave devices to select the first of the plurality of slave devices for the master device to communicate with, in response to said detecting the first frequency; and
asserting, by the distinct device, a second slave select signal to the second of the plurality of slave devices to select the second of the plurality of slave devices for the master device to communicate with, in response to said detecting the second frequency.

24. The method of claim 17, wherein the serial bus has a second single electrical path for conveying a slave select signal from the master device to the plurality of slave devices;
wherein said modulating the clock signal on the first single electrical path according to the first manner comprises generating a pulse train with a first predetermined number of clock edges on the first single electrical path prior to asserting the slave select signal on the second single electrical path; and
wherein said modulating the clock signal on the first single electrical path according to the second manner comprises generating a pulse train with a second predetermined number of clock edges on the first single electrical path prior to asserting the slave select signal on the second single electrical path, wherein the first and second predetermined number of clock edges are distinct.

25. The method of claim 24, further comprising:
detecting the pulse train with the first predetermined number of clock edges on the first single electrical path prior to asserting the slave select signal on the second single electrical path to determine that the master device is selecting the first of the plurality of slave devices; and
detecting the pulse train with the second predetermined number of clock edges on the first single electrical path prior to asserting the slave select signal on the second single electrical path to determine that the master device is selecting the second of the plurality of slave devices.

26. The method of claim 25, wherein said detecting the pulse train with the first predetermined number of clock edges on the first single electrical path prior to asserting the slave select signal on the second single electrical path is performed by the first of the plurality of slave devices, wherein said detecting the pulse train with the second predetermined number of clock edges on the first single electrical path prior to asserting the slave select signal on the second single electrical path is performed by the second of the plurality of slave devices.

27. The method of claim 25, wherein said detecting the pulse train with the first predetermined number of clock edges on the first single electrical path prior to asserting the slave select signal on the second single electrical path and said detecting the pulse train with the second predetermined number of clock edges on the first single electrical path prior to asserting the slave select signal on the second single electrical path are performed by a device distinct from the master device and distinct from the plurality of slave devices.

28. The method of claim 27, further comprising:
asserting, by the distinct device, a second slave select signal on a third single net to the first of the plurality of slave devices to select the first of the plurality of slave devices for the master device to communicate with, in response to said detecting the pulse train with the first predetermined number of clock edges on the first single electrical path prior to asserting the slave select signal on the second single electrical path; and
asserting, by the distinct device, a third slave select signal on a fourth single net to the second of the plurality of slave devices to select the second of the plurality of slave devices for the master device to communicate with, in response to said detecting the pulse train with the second predetermined number of clock edges on the first single electrical path prior to asserting the slave select signal on the second single electrical path.

29. The method of claim 25, further comprising:
commencing counting clock edges on the first single electrical path in response to deassertion of the slave select signal on the second single electrical path and stopping said counting in response to assertion of the slave select signal on the second single electrical path;
wherein said detecting the pulse train with the first predetermined number of clock edges on the first single electrical path comprises determining that the number of clock edges counted between said commencing and said stopping is the first predetermined number of clock edges;
wherein said detecting the pulse train with the second predetermined number of clock edges on the first single electrical path comprises determining that the number of clock edges counted between said commencing and said stopping is the second predetermined number of clock edges.

30. The method of claim 17, further comprising:
modulating the clock signal on the single electrical path according to a third manner to select a third of the plurality of slave devices, wherein the third manner is distinct from the first and second manners.
